(19) United States
(12) Patent Application Publication
(10) Pub. No.: US 2016/0253150 A1
(43) Pub. Date: Sep. 1, 2016

(54) Voice Controlled Marine Electronics Device

(71) Applicant: Navico Holding AS, Agersund (NO)

(72) Inventors: Blessing Anna Williams, Collinsville, OK (US); Jeffrey A. Hopkins, Las Vegas, NV (US)

(21) Appl. No.: 14/634,632

(22) Filed: Feb. 27, 2015

(51) Int. Cl. G06F 3/16; G06F 3/0481; G06F 3/0484; G10L 15/08

(52) U.S. Cl. CPC G06F 3/167; G10L 15/08; G06F 3/04817; G06F 3/04842

(57) ABSTRACT

Various implementations described herein are directed to a marine electronics device. The marine electronics device may include a microphone configured to receive one or more voice commands for performing one or more marine based tasks. The marine electronics device may include a processor and memory including instructions that cause the processor to perform the one or more marine based tasks corresponding to the one or more voice commands received via the microphone.

### BACKGROUND

This section is intended to provide information to facilitate an understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

When trolling for fish, a marine electronics display is useful for providing data and images to an angler. Interfacing with a marine electronics device may be beneficial. However, in some instances, when an angler's hands are busy holding a fishing pole, it may be difficult for the angler to physically adjust or change the display.

### SUMMARY

Described herein are implementations of technologies for a marine electronics device. The marine electronics device may include a microphone configured to receive one or more voice commands for performing one or more marine based tasks. The marine electronics device may include a processor and memory including instructions that cause the processor to perform the one or more marine based tasks corresponding to the one or more voice commands received via the microphone.

Described herein are further implementations of various technologies for a marine electronics device. The marine electronics device may include a display configured to provide an interface with an icon for selecting a voice command mode of operation. The marine electronics device may include a microphone configured to receive audio input for one or more voice commands. The marine electronics device may include a computer configured to activate the voice command mode of operation based on receiving an input from the display corresponding to selection of the icon. The computer may be further configured to perform one or more marine based tasks corresponding to the one or more voice commands received as audio input via the microphone.

Described herein are also implementations of technologies for a system having a wireless microphone. The wireless microphone may be configured to receive one or more voice commands, and transmit wireless signals corresponding to the one or more voice commands. The system may include a marine electronics device coupled to a marine vessel. The marine electronics device may include a processor and memory including instructions that cause the processor to receive the wireless signals from the wireless microphone, process the wireless signals to identify the one or more voice commands, and perform one or more tasks corresponding to the one or more voice commands.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Moreover, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIGS. 1A-1B illustrate various diagrams of voice controlled marine electronics device in accordance with various implementations described herein.

FIGS. 2A-2B illustrate various block diagrams of voice controlled marine electronics device systems in accordance with various implementations described herein.

FIGS. 3-5 illustrate various process flows of methods for using and/or operating voice controlled marine electronics device in accordance with various implementations described herein.

### DETAILED DESCRIPTION

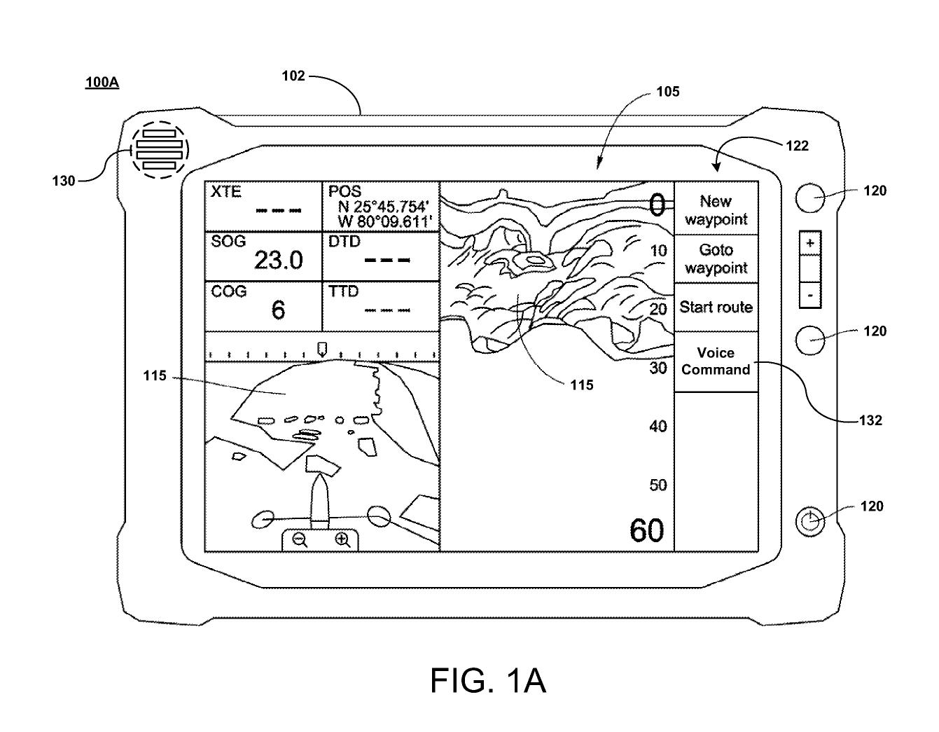

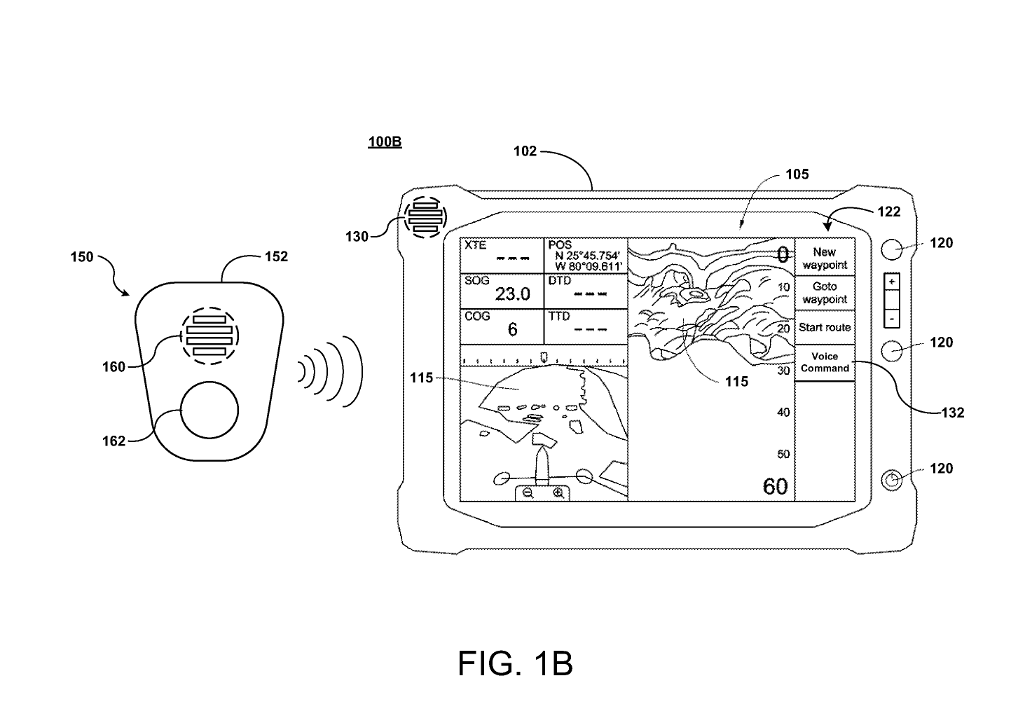

Various implementations of a voice controlled marine electronics device and use thereof will now be described in reference to FIGS. 1A-5.

FIGS. 1A-1B illustrate various diagrams of voice controlled marine electronics device in accordance with various implementations described herein. In particular, FIG. 1A illustrates a diagram of a marine electronics device 100A configured for voice control using a built-in microphone 130, and FIG. 1B illustrates a diagram of another marine electronics device 100B configured for voice control using a wireless microphone 150. The marine electronics device 100A, 100B may be coupled to a marine vessel (e.g., boat, ship, etc.) and may be referred to as a multi-function display (MFD). The marine electronics device 100A, 100B may be configured for processing and/or displaying multiple types of marine electronics data. Further, the marine electronics device 100A, 100B may be configured as a fish finder, a mapping device, a navigation device, a sailing device, an angler device, and/or various other devices used for marine based applications.

In reference to FIG. 1A, the marine electronics device 100A may include a housing 102 with a display screen 105 configured to display various data, information, and/or images, including one or more selectable icons 122, such as, e.g., a voice command icon 132 that may be associated with a voice command mode of operation. The display screen 105 may be configured to receive input from a user (e.g., angler, fisherman, captain, etc.) via selecting one or more of the selectable icons 122 including the voice command icon 132. The marine electronics device 100A may include a microphone, such as, e.g., the built-in microphone 130, configured to receive one or more voice commands for performing one or more tasks. In some instances, the one or more tasks may include marine based tasks, such as altering, modifying, and/or changing a mode of operation and/or altering, modifying, or changing output displayed on the display screen 105.

In some implementations, the microphone 130 may be built-in or integrated in the housing 102 of the marine electronics device 100A. The microphone 130 may be coupled to an interior region within the housing 102 of the marine electronics device 100A. The microphone 130 may be configured to receive one or more voice command signals, such as, e.g., audio signals associated with human vocalized sounds associated with annunciation of one or more words. As shown, the housing 102 may include one or more elongated apertures formed through the housing adjacent to the microphone 130, so that sound waves related to the one or more voice commands may pass through the elongated apertures and impinge on the microphone 130. Generally, the microphone 130 may include an acoustic-to-electric transducer or sensor that is configured to convert sound waves passing through an air medium into an electrical signal, which may be referred to as an analog audio signal. Further, the microphone 130 may be configured to utilize various technologies, related to sound capture, such as, e.g., condenser type microphones, piezoelectric type microphones, dynamic microphones, and the like, to produce electrical signals from air pressure variations. In some implementations, the marine electronics device 100A may include one or more amplifiers (e.g., preamplifier, audio power amplifier, etc.) that may be connected to the microphone 130 before the received analog audio signal is recorded or digitized (i.e., digitally converted).

In various implementations, the marine electronics device 100A may be configured as a voice controlled computing device or system for interfacing with the microphone 130 to receive voice commands for performing tasks including marine based tasks related to the voice commands. Further, the marine electronics device 100A may include various standard elements and/or components, including at least one processor, memory (e.g., non-transitory computer-readable storage medium), database, power, peripherals, and/or various other computing related components. The marine electronics device 100A may include instructions stored in memory that may cause the processor to receive an input selection signal from the display screen 105 and activate a voice command mode of operation based on receiving the input selection signal. The input selection signal may correspond to input received via selecting the voice command icon 132. The marine electronics device 100A may be configured to associate the one or more voice commands to a predetermined set of operations to perform the one or more tasks including marine based tasks corresponding to the one or more voice commands. In various instances, the set of operations may refer to a series of events (or instructions) that take place to fulfil a task (e.g., marine based task) associated with a received voice command.

In reference to FIG. 1A, the marine electronics device 100A may be operational with numerous general purpose or special purpose computing system environments and/or configurations. The marine electronics device 100A may include any type of electronics device capable of processing data and information (e.g., audio data and information). The marine electronics device 100A may be operational with various marine instruments, such that the marine electronics device 100A may display and/or process one or more types of marine electronics data 115. The marine electronic data 115 may include various chart data, radar data, sonar data, steering data, dashboard data, navigation data, fishing data, engine data, and the like.

As shown in FIG. 1A, the marine electronics device 100A includes the screen 105. In some instances, the screen 105 may be sensitive to touching by a finger. In some other instances, the screen 105 may be sensitive to the body heat from the finger, a stylus, or responsive to a mouse. The marine electronics device 100A may be configured to display data, information, and images associated with environmental sensors and various conditions related to a column of water on the screen 105. In some instances, environmental data, information, and images associated with detected environmental conditions of a column of water may be displayed on the screen 105 by overlaying various environmental data and information on chart and sonar images. In some instances, various environmental data and information may include current levels of environmental conditions at particular depths, upper and lower boundary levels at particular depths, average levels through a water column, and any fluctuations and/or changes that may occur throughout sensor use during a particular time period or interval.

The marine electronics device 100A may include one or more buttons, which may include physical buttons 120 or virtual buttons, such as, e.g., the one or more selectable icons 122 including the voice command icon 132, or some combination thereof that may be configured to activate and/or implement various modes of operation, including, e.g., a voice command mode of operation. Further, in some implementations, the marine electronics device 100A may receive input through the screen 105 via touch sensitive buttons or icons 122, 132.

In reference to FIG. 1B, the wireless microphone 150 may be provided as a remote communication device and used to communicate with the marine electronics device 100B, which is similar to the marine electronics device 100A of FIG. 1A, having similar components and features with similar scope and functionality. In some implementations, the wireless microphone 150 may be configured to receive one or more voice commands from a user via a microphone component 160 and transmit wireless signals corresponding to the one or more voice commands to the marine electronics device 100B. Further, the marine electronics device 100B may have a processor and memory including instructions that cause the processor to receive the wireless signals from the wireless microphone 150, process the wireless signals to identify the one or more voice commands, and perform one or more tasks including marine based tasks associated with the one or more voice commands.

In various implementations, the wireless microphone 150 may include the microphone component 160 as built-in or integrated in a housing 152 of the wireless microphone 150. The microphone component 160 may be coupled to an interior region within the housing 152 of the wireless microphone 150. The microphone component 160 may be configured to receive one or more voice command signals, such as, e.g., audio signals associated with human vocalized sounds associated with annunciation of one or more words. As shown in FIG. 1B, the housing 152 may include one or more elongated apertures formed through the housing adjacent to the microphone component 160, so that sound waves associated with the one or more voice commands may pass through the elongated apertures and impinge on the microphone component 160. The microphone component 160 may be similar in scope and functionality to the built-in microphone 130 of FIG. 1A.

In various implementations, the wireless microphone 150 may include one or more selector switches or buttons, which may include at least one selector switch 162 configured to activate the wireless microphone 150 and/or open a communication channel with the marine electronics device 100B. The selector switch 162 may be referred to as a user selectable switch or button configured to receive input from a user for transmitting wireless signals corresponding to one or more voice commands to the marine electronics device 100B. The selector switch 162 may be configured to provide activation of a single instance of a voice command with a single depression, or the selector switch 162 may be configured to provide activation of more than one instance of same or different voice commands when held down or continuously depressed over an interval of time. The selector switch 162 may be configured for hands free operation, where a first depression may activate the wireless microphone 150 to accept and/or receive voice commands, and a second depression may then deactivate the wireless microphone 150 to no longer accept and/or receive voice commands.

In various implementations, the wireless microphone 150 may be coupled to the user, such as, e.g., coupled to a user's wrist or a user's jacket, for ease of use and within vocal range of a user's mouth. For instance, the wireless microphone 150 may be coupled to a user's wrist near a first hand so that the user may easily depress the physical button 162 with a second hand while positioning the wireless microphone 160 near the user's mouth. In this instance, the user may easily speak voice commands into the microphone component 160 of the wireless microphone 150. In another instance, the wireless microphone 150 may be coupled to a user's jacket near a lapel of the jacket so that the user may easily depress the physical button 162 and activate the wireless microphone 150. In this instance, positioning the wireless microphone 160 on a lapel of a jacket near the user's mouth allows the user to easily speak voice commands into the microphone component 160 of the wireless microphone 150.

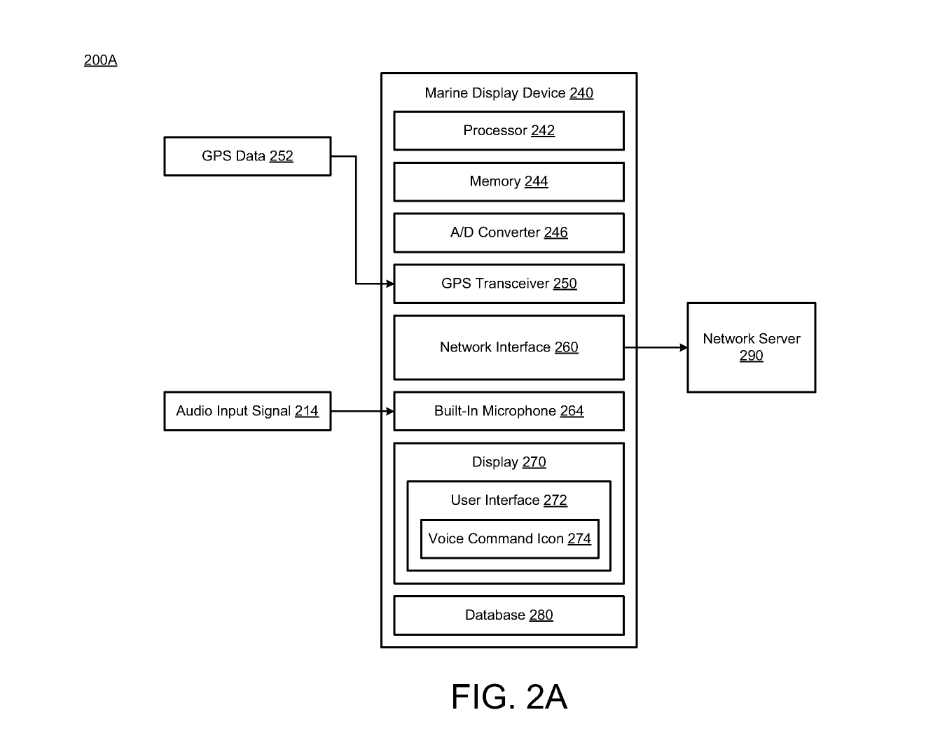

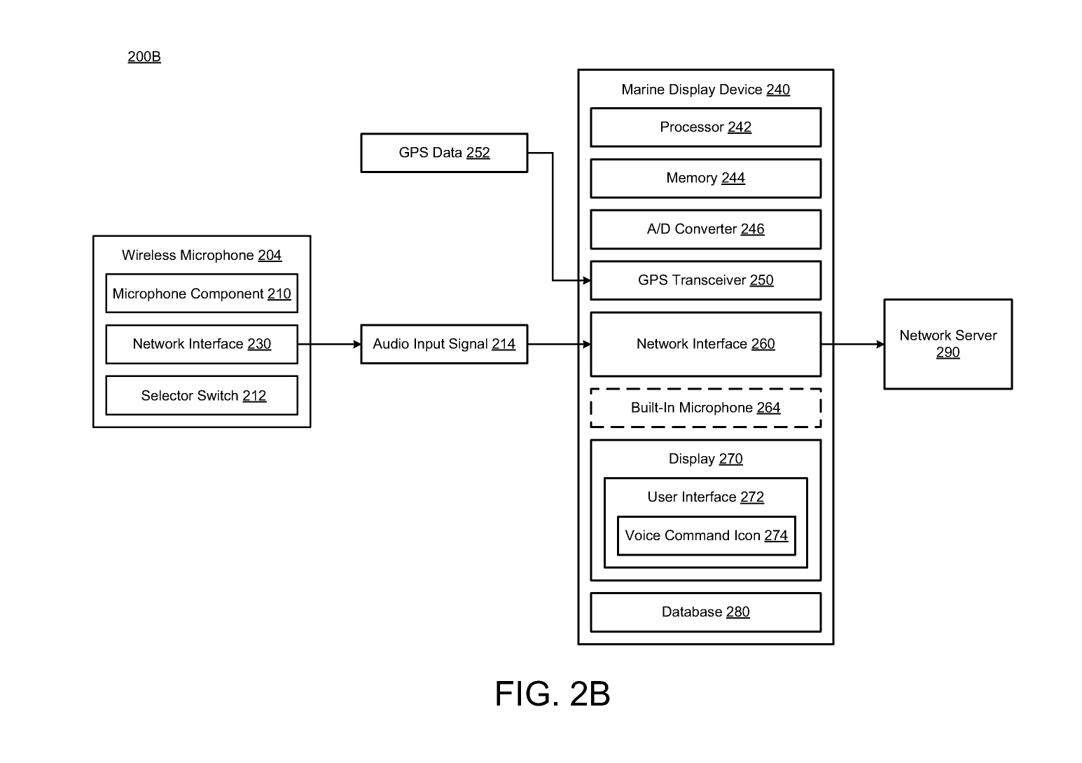

FIGS. 2A-2B illustrate various block diagrams of voice controlled marine electronics device systems in accordance with implementations described herein. In particular, FIG. 2A illustrates a block diagram of a marine electronics device system 200A configured for voice control using a built-in microphone 264, and FIG. 2B illustrates another block diagram of a marine electronics device system 200B configured for voice control using a wireless microphone 204 in accordance with various implementations described herein.

In reference to FIG. 2A, the marine electronics device system 200A may include a marine electronics device 240 and a network server 290. In various implementations, the marine electronics device 240 may include the built-in microphone 264 configured to receive one or more voice commands via audio input signals 214. The marine electronics device 240 may be coupled to a marine vessel, and the marine electronics device 240 may include functionality of a fish finder, a mapping device, a navigation device, or similar. Further, the marine electronics device 240 may be implemented as a computing device configured to transmit or upload marine related data, information, and/or images to the network server 290 over a wired or wireless communication channel or network via a network interface 260. The network server 290 may be a cloud server or other network server.

In various implementations, the marine electronics device 240 may be configured as a special purpose machine for interfacing with the built-in microphone 264. Further, the marine electronics device 240 may include a computer with various standard computing elements and/or components, including at least one processor 242, memory 244 (e.g., non-transitory computer-readable storage medium), at least one database 280, power, peripherals, and/or various other computing components that may not be specifically shown in FIG. 2A. Further, the marine electronics device 240 may include a display 270 (e.g., a monitor or other computer display) that may be used to provide a user interface (UI) 272, such as, e.g., a graphical user interface (GUI), with a voice command icon 274, which may be used to select a voice command mode of operation. In some instances, the display 270 may include a touch screen display. In FIG. 2A, the display 270 is shown as an incorporated part of the marine electronics device 240; however, the display 270 may be implemented as a separate component. Further, the UI 272 may be used to receive one or more preferences from a user of the display 270 for managing or utilizing the marine electronics device system 200A, including interfacing with the marine electronics device 240 and the built-in microphone 264. As such, in various instances, a user may setup desired behavior of the marine electronics device system 200A and/or built-in microphone 264 via user-selected preferences using the UI 272 associated with the display 270. Various elements and/or components of the marine electronics device system 200A that may be useful for the purpose of implementing the system 200A may be added, included, and/or interchanged, in manner as described herein.

Further, in reference to FIG. 2A, the built-in microphone 264 may be configured to receive one or more voice commands from a user for performing one or more tasks including marine based tasks. The memory 244 may include instructions that cause the processor 242 to perform one or more marine based tasks corresponding to one or more voice commands received via the microphone 264. In some instances, the one or more voice commands may include one or more human vocalized sounds associated with annunciation of one or more words including scroll-up, scroll-down, zoom-in, zoom-out, and/or display-side-scan. In other instances, the one or more words may include open document, open image, file search, command search, image search, volume-up, volume-down, display sonar, display chart, man overboard (MOB), record sonar, stop recording sonar, way point, new route, and various other words and/or phrases that may be associated with marine based applications.

The display 270 may be configured to display the voice command icon 274 associated with a voice command mode of operation and further configured to receive input via a user selecting the voice command icon 274. In this instance, the memory 244 may include instructions that may cause the processor 242 to receive an input selection signal from the display 270 corresponding to input received via selecting the voice command icon 274 and activate the voice command mode of operation based on receiving the input selection signal. Further, in this instance, the memory 244 may include instructions that may cause the processor 242 to associate the one or more voice commands to a predetermined set of operations to perform the one or more marine based tasks corresponding to the one or more voice commands.

In some implementations, the memory 244 may include instructions that may cause the processor 242 to receive the one or more voice commands as analog audio input (i.e., audio input signals 214) via the built-in microphone 264, and then store the received analog audio input in the memory 244 (or in database 280). The memory 244 may include instructions that cause the processor 242 to convert the analog audio input to digital audio data, and store the digital audio data in the memory 244 (or in database 280). The memory 244 may further include instructions that cause the processor 242 to associate the digital audio data to a predetermined set of operations to perform one or more tasks (e.g., marine based tasks) corresponding to the one or more voice commands.

In some implementations, the instructions that cause to processor 242 to associate the digital audio data to the predetermined set of operations (e.g., to perform one or more marine based tasks corresponding to one or more voice commands) may further cause the processor 242 to compare the digital audio data with one or more predetermined digital audio files stored in the memory 244 (or in database 280). In this instance, if a match is identified, the instructions cause to processor 242 to retrieve the predetermined set of operations to perform the one or more marine based tasks corresponding to the one or more voice commands. Further, in this instance, if a match is not identified, the instructions may cause to processor 242 to provide feedback or an indication to a user that no matching voice command was identified. In some instances, the indication may include a flashing or blinking image on the display 270 or from a light emitting diode (LED) attached to a housing of the marine electronics device 240. In some other instances, the marine electronics device 240 may include a speaker, and the indicator may be an audible warning signal being produced from the speaker.

In some implementations, the marine electronics device 240 may include an analog-to-digital (A/D) converter 246 configured to receive analog audio signals (i.e., audio input signals 214) from the built-in microphone 264, convert the received analog audio signals to digital audio data, and output the digital audio data to the processor 242 for processing. In this instance, the memory 244 may include instructions that cause the processor 242 to receive the digital audio data from the analog-to-digital converter 246 and perform the one or more marine based tasks corresponding to the one or more voice commands based on the digital audio data.

In some implementations, the marine electronics device 240 may be configured to receive geo-coordinate data, such as global positioning system data (i.e., GPS data 252), via a GPS receiver or transceiver 250 and display the received GPS data 252 on the display 270. In some instances, the one or more voice commands may include a voice command to display GPS coordinate data on the display 270.

In reference to FIG. 2B, the marine electronics device system 200B may include the marine electronics device 240 and the network server 290. The marine electronics device 240 may be configured to communicate with the wireless microphone 204 and receive one or more voice commands from a user via audio input signals 214. Further, in various implementations, the wireless microphone 204 may be configured to receive one or more voice commands from a user via a microphone component 210 and transmit wireless signals (i.e., audio input signals 214) corresponding to the one or more voice commands via a network interface 230. The network interface 230 of the wireless microphone 204 may include a transceiver or transmitter configured to communicate with the network interface 260 of the marine electronics device 240. In this instance, the network interface 260 of the marine electronics device 240 may include a transceiver or receiver configured to receive the wireless signals (i.e., audio input signals 214) from the wireless microphone 204. Further, the marine electronics device 240 may include the processor 242 and the memory 244 including instructions that cause the processor 242 to receive the wireless signals from the wireless microphone 204, process the wireless signals to identify the one or more voice commands, and perform one or more tasks (e.g., marine based tasks) associated with the one or more voice commands.

In various implementations, the wireless microphone 204 may include one or more switches or buttons, which may include at least one selector switch 212 configured to activate the wireless microphone 204 and/or open a communication channel with the marine electronics device 24. In some implementations, the selector switch 212 may be referred to as a user selectable switch or button configured to receive input from a user for transmitting wireless signals corresponding to one or more voice commands to the marine electronics device 240. In various implementations, the selector switch 212 may be configured with similar scope and function as the selector switch 162 described in reference to FIG. 1B. Further, in the implementation of FIG. 1B, the marine electronics device 240 may optionally include the built-in microphone 264, as described in reference to FIG. 1A. In this instance, a user may be able to selectively activate/deactivate each of the wireless microphone 204 and the built-in microphone 264.

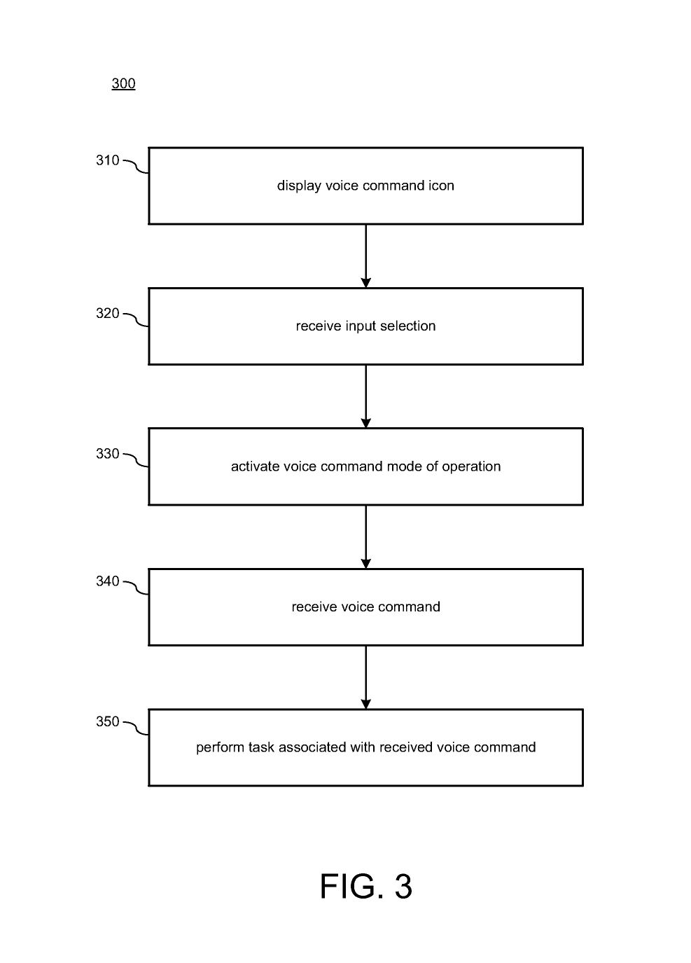

FIGS. 3-5 illustrate various process flows of methods for using and/or operating voice controlled marine electronics device in accordance with various implementations described herein. Methods of FIGS. 3-5 may be performed by a voice controlled marine electronics device, such as a voice controlled MFD.

FIG. 3 illustrates a process flow diagram for a method 300 of using and/or operating a marine electronics device in accordance with implementations of various techniques described herein. It should be understood that while method 300 indicates a particular order of execution of various operations, in some instances, certain portions of the operations may be executed in a different order, and on different systems. Further, additional operations or steps may be added to method 300. Similarly, some operations or steps may be omitted.

At block 310, method 300 may display a voice command icon. In some instances, a voice command icon associated with a voice command mode of operation may be displayed on a display component of a marine electronics device.

At block 320, method 300 may receive an input selection. In some instances, an input selection signal may be received from the display corresponding to input received via selecting the voice command icon.

At block 330, method 300 may activate a voice command mode of operation. In some instances, the voice command mode of operation may be activated based on receiving the input selection signal corresponding to the input received via selecting the voice command icon.

At block 340, method 300 may receive a voice command. In some instances, method 300 may receive one or more voice commands from a microphone (e.g., built-in microphone or wireless microphone). The one or more voice commands may include one or more human vocalized sounds associated with annunciation of one or more words. The one or more voice commands may be received as analog audio input via a microphone. The received analog audio input may be stored in memory.

At block 350, method 300 may perform a task associated with the received voice command. In some instances, method 300 may perform one or more tasks (e.g., marine based tasks) corresponding to the one or more voice commands received via the microphone. The one or more voice commands may be associated with a predetermined set of operations (or set of instructions) to perform one or more tasks (e.g., marine based tasks) corresponding to the one or more voice commands.

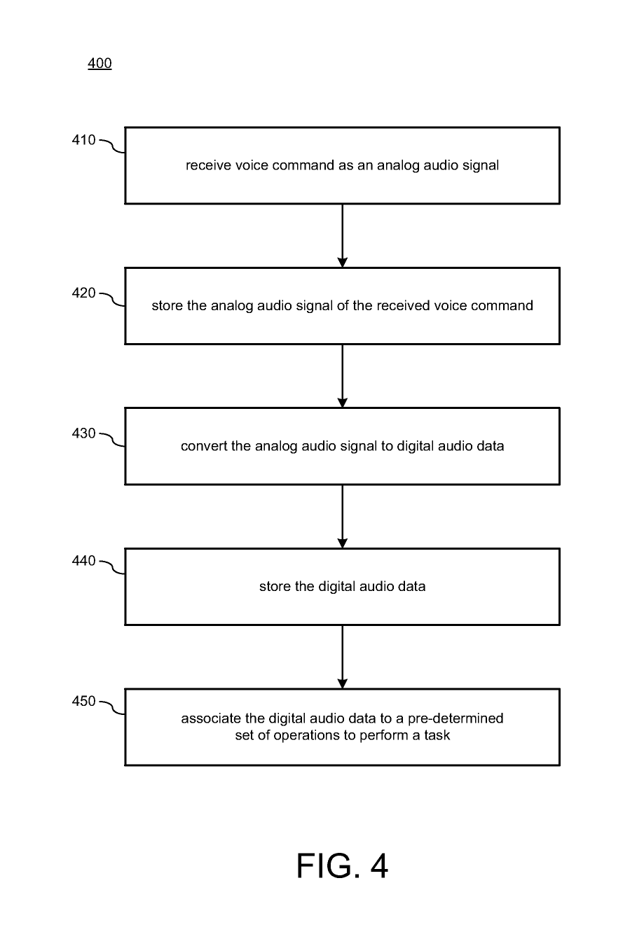

FIG. 4 illustrates a process flow diagram for another method 400 of using and/or operating a marine electronics device in accordance with implementations of various techniques described herein. It should be understood that while method 400 indicates a particular order of execution of operations, in some instances, certain portions of the operations may be executed in a different order, and on different systems. Further, additional operations or steps may be added to method 400. Similarly, some operations or steps may be omitted.

At block 410, method 400 may receive a voice command as an analog audio signal. In some instances, one or more voice commands may be received as analog audio input via a microphone. As described herein, the microphone may include a built-in microphone or a wireless remote microphone.

At block 420, method 400 may store the analog audio signal of the received voice command. In some instances, the received analog audio signal may be stored in memory.

At block 430, method 400 may convert the analog audio signal to digital audio data. In some instances, the received analog audio signal may be processed with a signal processing component or module and converted to digital audio data. The digital audio data may include a digital representation of the analog audio signals. The digital audio data may include data and information related to an analog-to-digital conversion that provides a binary representation of the analog audio signal, including, e.g., voltage amplitude of the analog audio signal over a predetermined time interval. The digital audio data may be output for further processing and/or analysis.

At block 440, method 400 may store the digital audio data. The digital audio data may be stored in memory. In some instances, the digital audio data related to the analog-to-digital conversion of the analog audio signal may be stored in memory.

At block 450, method 400 may associate the digital audio data to a predetermined set of operations (or set of instructions) to perform a task. In some instances, the task may include one or more marine based tasks corresponding to the one or more voice commands received by the microphone.

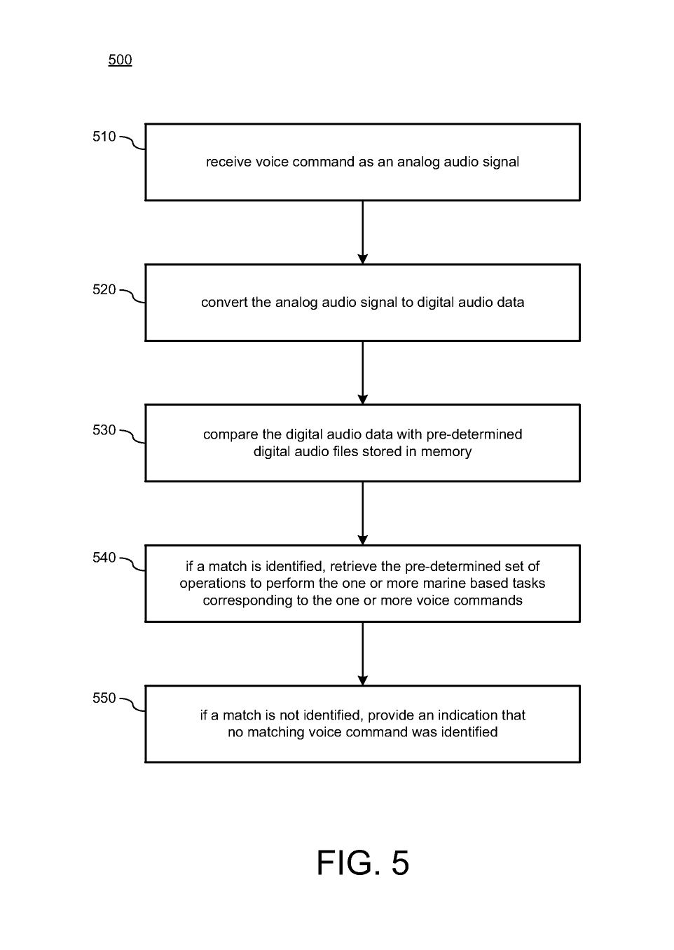

FIG. 5 illustrates a process flow diagram for another method 500 of using and/or operating a marine electronics device, such as a voice controlled marine electronics device, in accordance with implementations of various techniques described herein. It should be understood that while method 500 indicates a particular order of execution of operations, in some instances, certain portions of the operations may be executed in a different order, and on different systems. Further, additional operations or steps may be added to method 500. Similarly, some operations or steps may be omitted.

At block 510, method 500 may receive a voice command as an analog audio signal. As described herein, voice commands may be received as analog audio input via a microphone, such as a built-in microphone or a wireless remote microphone.

At block 520, method 500 may convert the analog audio signal to digital audio data. As described herein, signal processing may be used to convert the received analog audio signal to digital audio data, wherein the digital audio data may include a digital representation of the analog audio signals. In some instances, the digital audio data may be output for further signal processing and/or analysis.

At block 530, method 500 may compare the digital audio data with predetermined digital audio files stored in memory. For instance, a standard set of digitized audio files for various predetermined voice commands may be stored in memory and accessed/used for comparison with received voice commands to determine which voice commands are selected to be performed. In another instance, the marine electronics device may be configured with a learning mode of operation, where a user may input custom voice commands for implementation on the marine electronics device, and these custom audio files may be accessed/used for comparison with received voice commands to determine which voice commands are selected to be performed.

At block 540, method 500 may, if a match is identified, retrieve the predetermined set of operations to perform the task, including one or more marine based tasks, corresponding to the one or more voice commands. Otherwise, at block 550, method 500 may, if a match is not identified, provide an indication that no matching voice command was identified. As described herein, an indication may include one or more of displaying a flashing or blinking image on a display, flashing or blinking a LED, and/or an audible warning via a speaker component.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, tablets, wearable computers, cloud computing systems, virtual computers, marine electronics devices, and the like.

The various technologies described herein may be implemented in general context of computer-executable instructions, such as program modules, being executed by a computer. Generally, program modules may include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some instances, program modules may be implemented on separate computing systems and/or devices adapted to communicate with one another. Further, a program module may be some combination of hardware and software where particular tasks performed by the program module may be done either through hardware, software, or both.

The various technologies described herein may be implemented in the context of marine electronics, such as devices found in marine vessels and/or navigation systems. Ship instruments and equipment may be connected to the computing systems described herein for executing one or more navigation technologies. The computing systems may be configured to operate using various radio frequency technologies and implementations, such as sonar, radar, GPS, and like technologies.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

### Marine Electronics Device

In various implementations, each voice controlled marine electronics device described herein may be referred to as a voice controlled marine electronics device or as a voice controlled MFD. The marine electronics device may include one or more components disposed at various locations on a marine vessel. Such components may include one or more data modules, sensors, instrumentation, and/or any other devices known to those skilled in the art that may transmit various types of data to the marine electronics device for processing and/or display. The various types of data transmitted to the marine electronics device may include marine electronics data and/or other data types known to those skilled in the art. The marine electronics data received from the marine electronics device or system may include chart data, sonar data, structure data, radar data, navigation data, position data, heading data, automatic identification system (AIS) data, Doppler data, speed data, course data, or any other type known to those skilled in the art.

In one implementation, the marine electronics device may include a radar sensor for recording the radar data and/or the Doppler data, a compass heading sensor for recording the heading data, and a position sensor for recording the position data. In another implementation, the marine electronics device may include a sonar transducer for recording the sonar data, an AIS transponder for recording the AIS data, a paddlewheel sensor for recording the speed data, and/or the like.

The marine electronics device may receive external data via a LAN or a WAN. In some implementations, external data may relate to information not available from various marine electronics systems. The external data may be retrieved from various sources, such as, e.g., the Internet or any other source. The external data may include atmospheric temperature, atmospheric pressure, tidal data, weather, temperature, moon phase, sunrise, sunset, water levels, historic fishing data, and/or various other fishing and/or trolling related data and information.

The marine electronics device may be attached to various buses and/or networks, such as, e.g., a National Marine Electronics Association (NMEA) bus or network. The marine electronics device may send or receive data to or from another device attached to the NMEA 2000 bus. For instance, the marine electronics device may transmit commands and receive data from a motor or a sensor using an NMEA 2000 bus. In some implementations, the marine electronics device may be capable of steering a marine vessel and controlling the speed of the marine vessel, i.e., autopilot. For instance, one or more waypoints may be input to the marine electronics device, and the marine electronics device may be configured to steer the marine vessel to the one or more waypoints. Further, the marine electronics device may be configured to transmit and/or receive NMEA 2000 compliant messages, messages in a proprietary format that do not interfere with NMEA 2000 compliant messages or devices, and/or messages in any other format. In various other implementations, the marine electronics device may be attached to various other communication buses and/or networks configured to use various other types of protocols that may be accessed via, e.g., NMEA 2000, NMEA 0183, Ethernet, Proprietary wired protocol, etc. In some implementations, the marine electronics device 500 may communicate with various other devices on the vessel or watercraft via wireless communication channels and/or protocols.

In some implementations, the marine electronics device may be connected to a global positioning system (GPS) receiver. The marine electronics device and/or the GPS receiver may be connected via a network interface. In this instance, the GPS receiver may be used to determine position and coordinate data for a marine vessel on which the marine electronics device is disposed. In some instances, the GPS receiver may transmit position coordinate data to the marine electronics device. In various other instances, any type of known positioning system may be used to determine and/or provide position coordinate data to/for the marine electronics device.

The marine electronics device may be configured as a computing system having a central processing unit (CPU), a system memory, a graphics processing unit (GPU), and a system bus that couples various system components including system memory to the CPU. The computing system may include one or more CPUs, which may include a microprocessor, microcontroller, processor, programmable integrated circuit, or some combination thereof. The CPU may include an off-the-shelf processor such as a Reduced Instruction Set Computer (RISC), or a Microprocessor without Interlocked Pipeline Stages (MIPS) processor, or a combination thereof. The CPU may also include a proprietary processor.

The GPU may be a microprocessor specifically designed to manipulate and implement computer graphics. The CPU may offload work to the GPU. The GPU may have its own graphics memory, and/or may have access to a portion of the system memory. As with the CPU, the GPU may include one or more processing units, and each processing unit may include one or more cores.

The CPU may provide output data to a GPU. Further, the GPU may generate user interfaces (Uls) including graphical user interfaces (GUIs) that provide, present, and/or display the output data. The GPU may also provide objects, such as menus, in the GUI. In some instances, a user may provide input by interacting with objects, and the GPU may receive input from interaction with objects and provide the received input to the CPU. Further, in some instances, a video adapter may be provided to convert graphical data into signals for a monitor, such as, e.g., a MFD. The monitor (e.g., MFD) may include a screen. In various instances, the screen may be sensitive to touch by a human finger, and/or the screen may be sensitive to body heat from a human finger, a stylus, and/or responsive to a mouse.

The system bus may be any of several types of bus structures, including a memory bus or memory controller, a peripheral bus, and a local bus using any of a variety of bus architectures. By way of instance, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory may include a read only memory (ROM) and a random access memory (RAM). A basic input/output system (BIOS), containing the basic routines that help transfer information between elements within the computing system, such as during start-up, may be stored in the ROM.

The computing system may further include a hard disk drive interface for reading from and writing to a hard disk, a memory card reader for reading from and writing to a removable memory card, and an optical disk drive for reading from and writing to a removable optical disk, such as a CD ROM or other optical media. The hard disk, the memory card reader, and the optical disk drive may be connected to the system bus by a hard disk drive interface, a memory card reader interface, and an optical drive interface, respectively. The drives and their associated computer-readable media may provide nonvolatile storage of computer-readable instructions, data structures, program modules and other data for the computing system.

Although the computing system is described herein as having a hard disk, a removable memory card and a removable optical disk, it should be appreciated by those skilled in the art that the computing system may also include other types of computer-readable media that may be accessed by a computer. For instance, such computer-readable media may include computer storage media and communication media. Computer storage media may include volatile and non-volatile, and removable and non-removable media implemented in any method or technology for storage of information, such as computer-readable instructions, data structures, program modules, software modules, or other data. Computer-readable storage media may include non-transitory computer-readable storage media. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of instance, and not limitation, communication media may include wired media such as a wired network or direct-wired connection, and wireless media such as acoustic, radio frequency (RF), infrared (IR), and other wireless media. The computing system may include a host adapter that connects to a storage device via a small computer system interface (SCSI) bus, Fiber Channel bus, eSATA bus, or using any other applicable computer bus interface.

The computing system can also be connected to a router to establish a wide area network (WAN) with one or more remote computers. The router may be connected to the system bus via a network interface. The remote computers can also include hard disks that store application programs. In another implementation, the computing system may also connect to the remote computers via local area network (LAN) or the WAN. When using a LAN networking environment, the computing system may be connected to the LAN through the network interface or adapter. The LAN may be implemented via a wired connection or a wireless connection. The LAN may be implemented using Wi-Fi™′ technology, cellular technology, Bluetooth™ technology, satellite technology, or any other implementation known to those skilled in the art. The network interface may also utilize remote access technologies (e.g., Remote Access Service (RAS), Virtual Private Networking (VPN), Secure Socket Layer (SSL), Layer 2 Tunneling (L2T), or any other suitable protocol). In some instances, these remote access technologies may be implemented in connection with the remote computers. It will be appreciated that the network connections shown are exemplary and other means of establishing a communications link between the computer systems may be used.

A number of program modules may be stored on the hard disk, memory card, optical disk, ROM or RAM, including an operating system, one or more application programs, and program data. In certain implementations, the hard disk may store a database system. The database system could include, for instance, recorded points. The application programs may include various mobile applications (“apps”) and other applications configured to perform various methods and techniques described herein. The operating system may be any suitable operating system that may control the operation of a networked personal or server computer.

A user may enter commands and information into the computing system through input devices such as buttons, which may be physical buttons, virtual buttons, or combinations thereof. Other input devices may include a microphone, a mouse, or the like (not shown). These and other input devices may be connected to the CPU through a serial port interface coupled to system bus, but may be connected by other interfaces, such as a parallel port, game port or a universal serial bus (USB).

The discussion of the present disclosure is directed to certain specific implementations. It should be understood that the discussion of the present disclosure is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of the implementations and combinations of elements of different implementations within the scope of the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort maybe complex and time consuming, but would nevertheless be a routine undertaking of design, fabrication, and manufacture for those of ordinary skill having benefit of this disclosure. Nothing in this application should be considered critical or essential to the claimed subject matter unless explicitly indicated as being “critical” or “essential.”

Reference has been made in detail to various implementations, instances of which are illustrated in the accompanying drawings and figures. In the following detailed description, numerous specific details are set forth to provide a thorough understanding of the present disclosure. However, the present disclosure may be practiced without these specific details. In other instances, well-known methods, procedures, components, circuits and networks have not been described in detail so as not to unnecessarily obscure aspects of the embodiments.

It should also be understood that, although the terms first, second, etc. may be used herein to describe various elements, these elements should not be limited by these terms. These terms are only used to distinguish one element from another. For instance, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations and is not intended to limit the present disclosure. As used in the description of the present disclosure and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as instance forms of implementing the claims.

What is claimed is:

1. A marine electronics device, comprising:
a microphone configured to receive one or more voice commands for performing one or more marine based tasks;
a processor; and
memory including instructions that cause the processor to perform the one or more marine based tasks corresponding to the one or more voice commands received via the microphone.

2. The marine electronics device of claim 1, wherein the marine electronics device is coupled to a marine vessel, and wherein the marine electronics device comprises one or more of a fish finder, a mapping device, and a navigation device.

3. The marine electronics device of claim 1, wherein the one or more voice commands comprise one or more human vocalized sounds associated with annunciation of one or more words.

4. The marine electronics device of claim 1, further comprising:
a display configured to display a voice command icon associated with a voice command mode of operation and configured to receive input via selecting the voice command icon,
wherein the instructions further cause the processor to:
receive an input selection signal from the display corresponding to input received via selecting the voice command icon, and
activate the voice command mode of operation based on receiving the input selection signal.

5. The marine electronics device of claim 1, wherein the instructions further cause the processor to associate the one or more voice commands to a predetermined set of operations to perform the one or more marine based tasks.

6. The marine electronics device of claim 1, wherein the instructions further cause the processor to:
receive the one or more voice commands as analog audio input via the microphone; and
store the received analog audio input in the memory.

7. The marine electronics device of claim 1, wherein the instructions further cause the processor to:
receive the one or more voice commands as analog audio input via the microphone,
convert the analog audio input to digital audio data, and
store the digital audio data in the memory.

8. The marine electronics device of claim 1, wherein the instructions further cause the processor to:
receive the one or more voice commands as analog audio input via the microphone,
convert the analog audio input to digital audio data, and
associate the digital audio data to a predetermined set of operations to perform the one or more marine based tasks corresponding to the one or more voice commands.

9. The marine electronics device of claim 8, wherein the instructions that cause to processor to associate the digital audio data to the predetermined set of operations to perform the one or more marine based tasks corresponding to the one or more voice commands further cause the processor to:
compare the digital audio data with one or more predetermined digital audio files stored in the memory;
if a match is identified, retrieve the predetermined set of operations to perform the one or more marine based tasks corresponding to the one or more voice commands; and
if a match is not identified, provide an indication that no matching voice command was identified.

10. The marine electronics device of claim 1, wherein the marine electronics device further comprises:
an analog-to-digital converter configured to:
receive analog audio signals from the microphone,
convert the received analog audio signals to digital audio data, and
output the digital audio data,
wherein the instructions further cause the processor to:
receive the digital audio data from the analog-to-digital converter, and
perform the one or more marine based tasks corresponding to the one or more voice commands based on the digital audio data.

11. A marine electronics device, comprising:
a display configured to provide an interface with an icon for selecting a voice command mode of operation;
a microphone configured to receive audio input for one or more voice commands; and
a computer configured to:
activate the voice command mode of operation based on receiving an input from the display corresponding to selection of the icon, and
perform one or more marine based tasks corresponding to the one or more voice commands received as audio input via the microphone.

12. The marine electronics device of claim 11, wherein the display comprises a touch screen display, and wherein the interface comprises a graphical user interface with the icon.

13. The marine electronics device of claim 11, wherein the one or more voice commands comprise one or more human vocalized sounds associated with annunciation of one or more words.

14. The marine electronics device of claim 11, wherein the instructions further cause the processor to:
receive the one or more voice commands as analog audio input via the microphone,
convert the analog audio input to digital audio data, and
store the digital audio data in memory.

15. The marine electronics device of claim 11, wherein the instructions further cause the processor to:
receive the one or more voice commands as analog audio input via the microphone,
convert the analog audio input to digital audio data,
compare the digital audio data with one or more predetermined digital audio files stored in memory;
if a match is identified, retrieve a predetermined set of operations to perform the one or more marine based tasks corresponding to the one or more voice commands; and
if a match is not identified, provide an indication that no matching voice command is identified.

16. A system, comprising:
a wireless microphone configured to:
receive one or more voice commands, and
transmit wireless signals corresponding to the one or more voice commands; and
a marine electronics device coupled to a marine vessel, the marine electronics device having a processor and memory including instructions that cause the processor to:
receive the wireless signals from the wireless microphone,
process the wireless signals to identify the one or more voice commands, and
perform one or more tasks corresponding to the one or more voice commands.

17. The system of claim 16, wherein the one or more tasks are associated with marine based tasks or applications.

18. The system of claim 16, wherein the marine electronics device further comprises:
a display configured to display a voice command icon associated with a voice command mode of operation and receive input via selecting the voice command icon,
wherein the instructions further cause the processor to:
receive an input selection signal from the display corresponding to input received via selecting the voice command icon, and
activate the voice command mode of operation based on receiving the input selection signal.

19. The system of claim 16, wherein the marine electronics device comprises an analog-to-digital converter configured to:
receive the wireless signals as analog audio signals from the wireless microphone,
convert the received analog audio signals to digital audio data, and
output the digital audio data.

20. The system of claim 19, wherein the instructions further cause the processor to:
receive the digital audio data from the analog-to-digital converter, and
compare the digital audio data with one or more predetermined digital audio files stored in memory,
if a match is identified, retrieve a predetermined set of operations to perform the one or more tasks corresponding to the one or more voice commands, and
if a match is not identified, provide an indication that no matching voice command is identified.
